(19) United States
(12) Patent Application Publication
(10) Pub. No.: US 2004/0045496 A1
(43) Pub. Date: Mar. 11, 2004

(54) Magnetic bookmark

(76) Inventor: Tamie K. Smith, Temecula, CA (US)

Correspondence Address: George W. Dishong Esq., DISHONG LAW OFFICE, 40 Bryant Road, Jaffrey, NH, 03452, US

(21) Appl. No.: 10/651,798

(22) Filed: Aug. 30, 2003

Related U.S. Application Data
(63) Continuation-in-part of application No. 10/109,497, filed on Mar. 28, 2002, now abandoned.
Application No. 10/109,497 is a continuation-in-part of application No. 09/507,295, filed on Feb. 18, 2000, now Pat. No. 6,401,649.
(60) Provisional application No. 60/121,083, filed on Feb. 19, 1999.

(51) Int. Cl. B42D 9/00

(52) U.S. Cl. 116/234

(57) ABSTRACT

A magnetic placemarker for document pages that remains in place and retains its shape regardless of the orientation of the document, where multiple pages are to be marked, where a place on the page is to be marked, or where the adhesive properties of the marker are to remain stable, among other things. The placemarker is of flexible but structurally sturdy material such that adornments having independent structure can be affixed to outside surfaces of the placemarker. The placemarker can be fitted with a plurality of magnetic strips, including vertical magnetic strips.

### CROSS-REFERENCE TO RELATED APPLICATIONS

This application claims the benefit of Provisional Application Ser. No. 60/121,083 filed on Feb. 19, 1999, entitled MAGNETIC BOOKMARK, and is a continuation-in-part of pending Utility patent application Ser. No. 10/109,497, filed Mar. 28, 2002, which is a continuation-in-part of pending Utility patent application Ser. No. 09/507,295, filed Feb. 18, 2000, now issued.

### BACKGROUND OF THE INVENTION

This invention most generally relates to a magnetic device that can be used to mark places in books, magazines, newspapers, among other documents. More particularly the invention relates to placemarkers that adhere through magnetism, and are adorned with indicia.

Presently, inventions exist for placemarkers that protrude from the edge of the document, mark multiple places, mark multiple pages, and can be secured to the book These inventions solve particular problems such as creating thumb tabs on document edges, accommodating readers who require multiple marks in the same document, and insuring that the bookmark does not fall out of the book.

Magnetic bookmarks exist in which strips of flexible material such as cloth or paper are folded in half, adhesive is added to the ends of the material, and magnets are placed on the adhesive. Because the cloth or paper does not itself have the structural integrity to retain its shape during use, a second shorter strip is sometimes secured to the main strip and folded at or near the point of attachment. Alternatively, a separate strip is attached to the outer surface at the fold so that the marked position is visible to the reader. The separate strip, also of very flexible material such as cloth, can be engraved or otherwise marked. Nowhere is it disclosed that an item of substance, such as a button or jewel, is attached to the strips of flexible material that fold.

Magnetic fastening devices are disclosed that can have such items as nametags glued to them. These devices are used to adhere to clothing, refrigerators, etc., but are too bulky for thinner surfaces, such as pages in a document.

Clipped bookmarkers are disclosed in which the page is marked by the spring pressure action of two paperclip-type portions pressing on opposite sides of a page. In these types of devices, there are front and rear paperclip-type portions disclosed. The rear portion is disclosed with a side that is flush with the page and an opposite side that could have, for example, a magnet attached to it. The magnet is used to, for example, mount the bookmarker on a refrigerator. The clip-type bookmarker has the obvious disadvantage of being limited in the number of pages that can be gathered between its portions.

What is needed is a placemarker for document pages that has opposing magnets attached to or integral with material that is flexible but that holds its shape, such as flexible plastic. What is also needed is a placemarker that is rigid enough to be positioned so that part of it extends beyond the edge of the document, making the marked page(s) easy to locate, without the requirement of an additional strip. What is further required is a placemarker that could be adorned on any external side with all kinds of items, not simply inked lettering, but including buttons, bobbles, jewels, metals, etc. What is still further needed is a magnetic placemarker that can be folded in any way, not confined to a mid-point fold in order to insure the alignment of opposing magnets. What is still further needed is a magnetic placemarker that can be fabricated into any shape, the magnetic portion lying within the fold of the placemarker surrounding the pages of the document.

### SUMMARY OF THE INVENTION

The problems set forth above as well as further and other problems are solved by the present invention. The solutions and advantages of the present invention are achieved by the illustrative embodiment described hereinbelow.

A placemarker for a document that stays in place through magnetic force, holds it shape during use, can be formed of any shape, and is rigid enough to host items, the items having independent structure, is disclosed. The placemarker of the present invention includes a substrate, such as, for example, plastic, having weight and size suitable for surrounding pages in a document, the substrate having a first surface and an opposing second surface, the substrate being of sufficient rigidity to support items having independent substance, such as, for example, a button. The substrate can take any shape including, but not limited to, geometric, irregular, symbolic, animal, character, or plant. For example, the substrate could take the shape of a rectangle that is folded lengthwise, where a first portion of the substrate could fold over a first side of a page, and where the remainder of the substrate could fold over a second side of the page and be mutually attracted through magnetism to the first portion folded over the first side of the page. Alternatively, and by way of example, the substrate could have the shape of two baseballs, for example, connected by any means for connecting known in the art or fabricated in a connected way at an edge. Possible means for connecting could include, for example, but not limited to, hinges, snaps, or laces.

Any shape can be accomplished by cutting the substrate to the desired shape and affixing, if not already integrated, a magnetic substance to the first surface, i.e. the surface that surrounds the page when the placemarker is in use. The magnetic substance can have a plurality of mutually attractive portions that, when placed in alignment when the placemarker is in use, connect the portions to each other. The magnetic substance could include a plurality of magnets attached through adhesive to the first surface, or it could include a continuous magnetic surface attached to or integral with the first surface. Alternatively, the substrate could itself be a magnetic substance that, when folded, exhibits mutual attractive properties that hold the folded parts of the first surface together. Note that the folded parts could also be two separate parts, if the substrate is formed in two separate pieces, and could be connected by any means for connecting known in the art.

The substrate of the placemarker of the present invention is substantial enough so that items having structure independent from the substrate can be attached to the substrate without compromising the shape-holding integrity of the substrate. Thus, the placemarker of the present invention can include at least one item attached to the second surface such as a button, a charm, metal, a jewel, and other such articles of substance that could be attached with adhesive or other attaching means commonly known in the art. When the placemarker is folded, the second surface, the surface upon which at least one item is placed, is visible.

A method for making a placemarker is disclosed. The method of the illustrative embodiment of the present invention includes the steps of forming a substrate to a shape, the substrate having a first surface and an opposing second surface, the first surface having a first portion and a second portion; forming a magnetic attraction between the first portion and the second portion; and affixing at least one item to the second surface.

The placemarker of the present invention has the particular objective and advantage of remaining in the marked location no matter how the document is oriented, and no matter how many times the marker is used. This is because magnets, unlike adhesive or clip markers, do not lose their adhesive properties, nor stretch from use, nor vary in their ability to securely fasten after repeated use.

In the illustrative embodiment of the invention, the marker is constructed of a folded piece of sturdy material, on which inner sides of the folded material are affixed magnets. This embodiment of the marker can be folded over one or several pages, anywhere on the page to thus mark a specific location at which point, perhaps, reading was suspended.

For a better understanding of the present invention, together with other and further objects thereof, reference is made to the accompanying drawings and detailed description. The scope of the present invention is pointed out in the appended claims.

### BRIEF DESCRIPTION OF THE SEVERAL VIEWS OF THE DRAWING

FIG. 1A is a perspective view of the placemarker of the present invention when in use;

FIG. 1B is a transparent, perspective view of alternate embodiments of the placemarker of the present invention when in use;

FIG. 2 is a perspective view of the second surface of a rectangularly-shaped illustrative embodiment of the present invention;

FIG. 3 is a perspective view of the first surface of the rectangularly-shaped illustrative embodiment of the present invention;

FIGS. 4A and 4B are perspective views of a non-mid-point folded placemarker of a first alternate embodiment of the present invention; and

FIGS. 5A-C are perspective views of a second alternate embodiment of the present invention.

### DETAILED DESCRIPTION OF THE INVENTION

The present invention is now described more fully hereinafter with reference to the accompanying drawings, in which illustrative embodiments of the present invention aer shown.

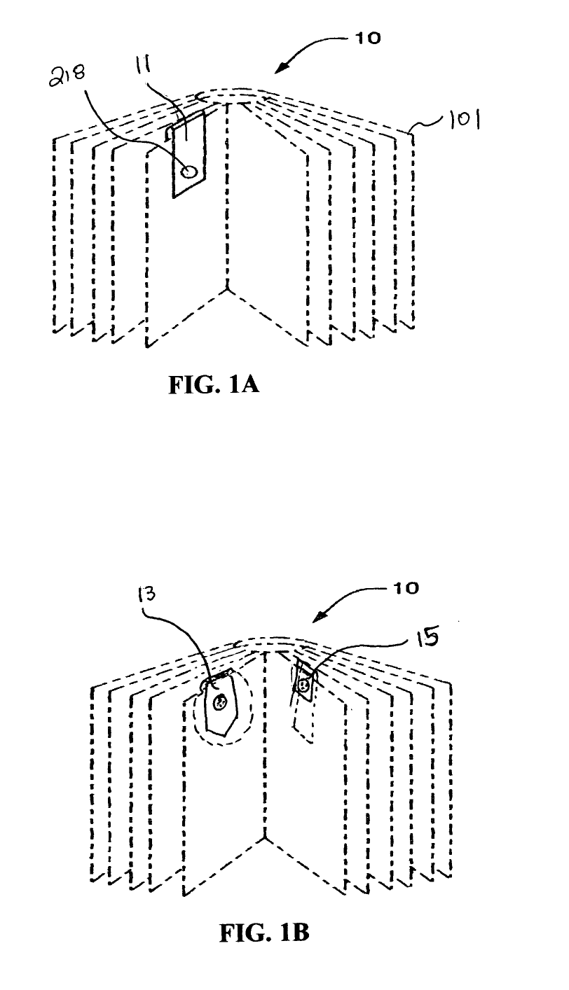

Referring to FIG. 1A, placemarker 10 can be removably attached to at least one page of document or book 101. Illustrative embodiment 11 is a rectangular placemarker that is formed by folding a substrate, that has been magnetized on its inner surface, over a page or pages in book 101. Button 218 is an exemplary item that is affixed to the outer surface of illustrative embodiment 11.

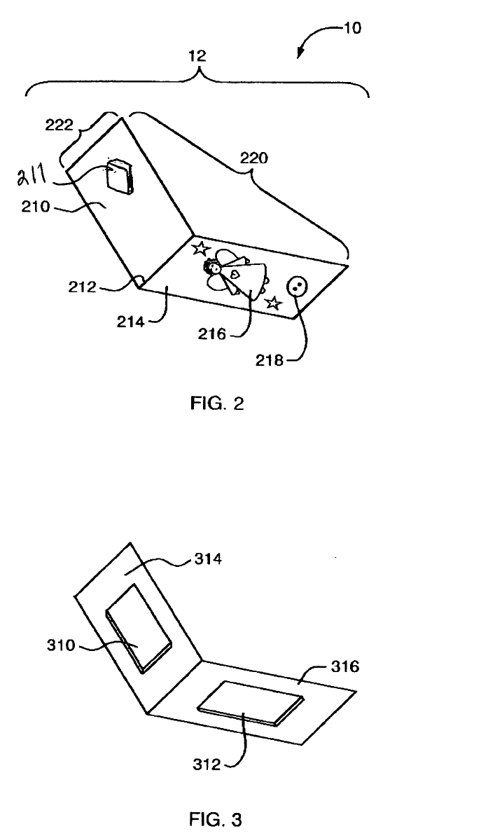

Referring now to FIG. 2, the outer surface of placemarker 10 is shown. Substrate 12, having predetermined averaged width 222 and averaged length 220 dimensions, is formed of a material that holds its shape when positioned in any way around the pages of a document, such as, for example, but not limited to, paperboard, plastic, magnetic strip, rubber, and vinyl. In addition, substrate 12 is of a weight suitable for surrounding the pages of a document. Geometric shape 211, character 216, and button 218 may be placed on rear and front portions 210 and 214. Substrate 12 can be fabricated to be, for example, foldable substantially about pivot point 212, thereby creating rear and front portions 210 and 214, respectively.

Referring now to FIG. 3, first magnetic segment 310 can be securely and perhaps removably affixed to first portion 314 that opposes of rear portion 210, and second magnetic segment 312 can be securely and perhaps removably affixed to second portion 316 that opposes front portion 214. First and second magnetic segments 310 and 312 respectively can be integral to substrate 12 as well. In operation, first and second magnetic segments 310 and 312 are oriented to be mutually attracted when substrate 12 is folded so that first and second portions 314 and 316 securely surround a document's page or pages. First and second magnetic segments 310 and 312 can be as large or small as needed or desired, and can each be multiple magnet segments, not being limited to a single segment. Substrate 12 can be a continuous magnetic strip.

Referring now to FIG. 1B, first alternate embodiment 15 and second alternate embodiment 13 of placemarker 10 are shown. First alternate embodiment 15 is a placemarker having front and rear portions of differing sizes, but the same shape (rectangular). Second alternate embodiment 13 is a placemarker having front and rear portions of differing shapes, in this case a polygon and a circle respectively.

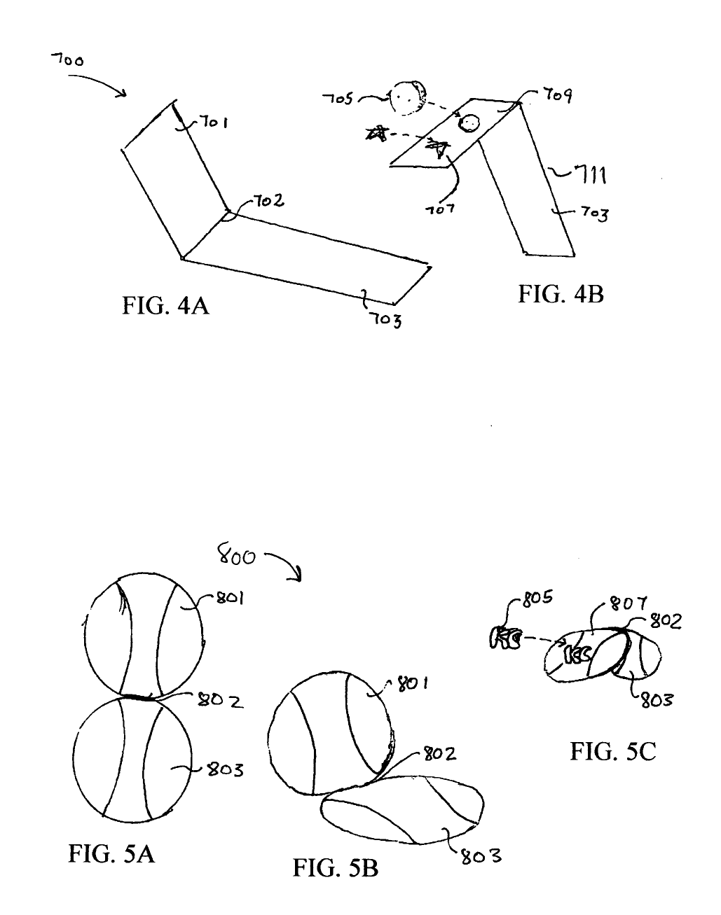

Referring now to FIG. 4A, first alternate embodiment 15 (FIG. 1B) is shown in detail. First surface 700 of the substrate is divided in unequal portions, first and second portions 701 and 703. First portion 701 is folded on fold line or means for connecting 702. The substrate could be folded at any point along its length or width Second portion 703 includes the remainder of the substrate. Referring to FIG. 4B, second surface front portion 709 hosts independent structure button 705 and geometric shape 707. Example items 705 and 707 have utility (as a button and star-shaped pin) separate from their use on the substrate, and are herein used as adornment to front portion 709, being attached through adhesive or other known means. Example items 705 and 707 could have been attached to rear portion 711 as well.

Referring again to FIG. 1B, second alternate embodiment 13 is shown in detail. Substrate 800 is formed into the shape, for example, of two baseballs. Shown in FIGS. 5A-B are first and second portions 801 and 803, respectively, hinged at fold line or means for connecting 802. Shown in FIG. 5C is second surface 807 adorned with nameplate 805, which is, in this example, a metal nameplate riveted onto the front portion of second surface 807. Note that second surface 807 is not required to contain identical sections across fold line or means for connecting 802, but can include, for example, a baseball on one side and a catcher's mitt on the other side.

The material used in the construction of the illustrative and alternate embodiments can include, but is not limited to, paperboard, plastic, magnetic strip, rubber, synthetics, and vinyl. Items 216, 218, 532, and 534 affixed to outward-facing surfaces 214 and 530 can include, but are not limited to, buttons, jewels, bobbles, charms, nameplates, photos, and metals.

Although the invention has been described with respect to various embodiments, it should be realized this invention is also capable of a wide variety of further and other embodiments within the spirit and scope of the appended claims.

What is claimed is:

1. A placemarker comprising:
a substrate having weight and size suitable for surrounding pages in a document, said substrate having a first surface and an opposing second surface, said first surface having a first portion and a second portion, said first portion having magnetic attraction to said second portion; and
at least one item having independent substance, said at least one item being affixed to said second surface.

2. The placemarker according to claim 1 wherein said substrate is selected from a group consisting of paperboard, plastic, magnetic strip, rubber, synthetics, and vinyl.

3. The placemarker according to claim 1 wherein said at least one item is selected from a group consisting of a buttons, jewels, bobbles, charms, nameplates, photos, and metals.

4. The placemarker according to claim 1 wherein said substrate can take a shape selected from a group consisting of geometric shapes, irregular shapes, symbols, animals, characters and plants.

5. The placemarker according to claim 1 wherein said magnetic attraction results from a material selected from a group consisting of a plurality of magnets, an integrated magnetic strip, an adhesive magnetic strip, and two magnetic strips placed vertically on said substrate.

6. The placemarker according to claim 1 wherein said second surface includes a front portion and a rear portion, said front portion having a front shape, said rear portion having a rear shape, said front shape being different from said rear shape.

7. The placemarker according to claim 1 wherein said second surface includes a front portion and a rear portion, said front portion having a front size, said rear portion having a rear size, said front size being different from said rear size.

8. A placemarker comprising:
at least one item;
a first substrate having a first shape and a first size, said first substrate having a first inner side and a first outer side, said first substrate having weight and size suitable for surrounding pages of a document, said at least one item being affixed to said first outer side, said first inner side having magnetic means;
a second substrate having a second shape and a second size, said second substrate having a second inner side and a second outer side, said second inner side having magnetic means; and
means for connecting said first substrate with said second substrate.

9. The placemarker according to claim 8 further comprising at least one second item, said at least one second item being affixed to said second outer side.

10. The placemarker according to claim 8 wherein said means for connecting is selected from a group consisting of a continuous connection between said first substrate and said second substrate, a connecting snap, a connecting tie, and a hinge.

11. A placemarker according to claim 8 wherein said first shape is selected from a group consisting of geometric, animal, plant, symbol, character, and irregular.

12. A placemarker according to claim 8 wherein said second shape is selected from a group consisting of geometric, animal, plant, symbol, character, and irregular.

13. A placemarker according to claim 8 wherein said first shape is different from said second shape.

14. A placemarker according to claim 8 wherein said first size is different from said second size.

15. The placemarker according to claim 8 wherein said first substrate is selected from a group consisting of paperboard, plastic, magnetic strip, rubber, synthetics, and vinyl.

16. The placemarker according to claim 8 wherein said second substrate is selected from a group consisting of paperboard, plastic, magnetic strip, rubber, synthetics, and vinyl.

17. A method for making a placemarker comprising:
forming a substrate to a shape, said substrate having a first surface and an opposing second surface, said first surface having a first portion and a second portion;
creating a magnetic attraction between said first portion and said second portion; and
affixing at least one item to said second surface.

18. The method according to claim 15 further comprising:
selecting the substrate from a group consisting of paperboard, plastic, magnetic strip, rubber, synthetics, and vinyl.

19. The method according to claim 15 further comprising:
selecting the shape from a group consisting of geometric, animal, plant, symbol, character, and irregular.

20. The method according to claim 15 further comprising:
selecting the at least one item from a group consisting of buttons, jewels, bobbles, charms, nameplates, photos, and metals.
